(19) United States
(12) Patent Application Publication
(10) Pub. No.: US 2016/0138521 A1
(43) Pub. Date: May 19, 2016

(54) CYLINDER BLOCK

(71) Applicant: TOYOTA JIDOSHA KABUSHIKI KAISHA, Toyota-shi (JP)

(72) Inventors: Satoko TOFUKUJI, Minato-ku (JP); Atsunori KUMAGAI, Sunto-gun (JP); Nobuki KAWAMOTO, Okazaki-shi (JP)

(73) Assignee: TOYOTA JIDOSHA KABUSHIKI KAISHA, Toyota-shi (JP)

(21) Appl. No.: 14/941,039

(22) Filed: Nov. 13, 2015

(30) Foreign Application Priority Data
Nov. 14, 2014 (JP) 2014-231031

(51) Int. Cl. F02F 7/00

(52) U.S. Cl. CPC F02F 7/007

(57) ABSTRACT

A cylinder block including two different systems of cooling water channels. The cooling water at a relatively low temperature is made to flow through a first cooling water channel, while the cooling water at a relatively high temperature is made to flow through a second cooling water channel. The first cooling water channel includes an exhaust-side water jacket that is located on an exhaust side with respect to a plurality of cylinders juxtaposed in a longitudinal direction of the cylinder block and is provided in the longitudinal direction along the plurality of cylinders. The second cooling water channel includes an intake-side water jacket that is located on an intake side with respect to the plurality of cylinders and is provided in the longitudinal direction along the plurality of cylinders.

### CROSS-REFERENCE TO RELATED APPLICATION

This application is based on and claims the benefit of priority of Japanese Patent Application No. 2014-231031, filed on Nov. 13, 2014, the entire contents of which are incorporated herein by reference.

### FIELD OF THE APPLICATION

The present application relates to a cylinder block of an internal combustion engine and more particularly to a cylinder block including two systems of channels through which cooling water flows.

### BACKGROUND ART

Japanese Patent Laid-Open No. 2010-014025 discloses a configuration in which a plurality of cooling water channels extending in a cylinder juxtaposed direction is provided on each of an intake side and an exhaust side of a cylinder. Each of the plurality of the cooling water channels is provided in a state divided along an axial direction of the cylinder. In this configuration, a flow rate of the cooling water flowing on an outer periphery of the cylinder can be changed with respect to the axial direction of the cylinder by a method such as differentiating inner diameters of inlet holes for introducing the cooling water into the cooling water channel among the cooling water channels and the like. As an example thereof, Japanese Patent Laid-Open No. 2010-014025 discloses that a flow rate of the cooling water channel which is on the exhaust side and is the closest to a top dead center of a piston is set larger than flow rates of the other cooling water channels. In a region close to the top dead center of the piston and on the exhaust side, an in-cylinder temperature can be the hottest due to an influence of a combustion gas, and by setting the flow rate of the cooling water channel which is the closest to this region at the maximum, a cooling effect for the cylinder can be made appropriate.

The cooling effect of the cylinder by the cooling water depends on the flow rate and the temperature of the cooling water. The technology disclosed in Japanese Patent Laid-Open No. 2010-014025 is a technology with an emphasis on the flow rate in them. However, the technology disclosed in Japanese Patent Laid-Open No. 2010-014025 does not consider the temperature of the cooling water. If the temperature of the cooling water can be changed instead of the flow rate or together with the flow rate in accordance with the location, the cooling effect for the cylinder can be made more appropriate.

### SUMMARY OF THE APPLICATION

The present application was made in view of the above-described problem and has an object to provide a cylinder block which can make the cooling effect for the cylinder appropriate by changing the temperature of the cooling water in accordance with the location.

A cylinder block according to the present disclosure is a cylinder block for a multi-cylinder engine and includes a plurality of cylinders (hereinafter referred to as a cylinder group) juxtaposed in a longitudinal direction. In this application, the “longitudinal direction” of the cylinder block is defined as a direction in which the cylinders are juxtaposed, that is, an axial direction of a crank shaft. Moreover, in this application, a direction orthogonal to the longitudinal direction and also orthogonal to the axial direction of the cylinder is referred to as a “width direction” of the cylinder block.

The cylinder block according to the present disclosure includes a first cooling water channel and a second cooling water channel as channels in the cylinder block through which cooling water flows. The first cooling water channel includes an exhaust-side water jacket. The exhaust-side water jacket is located on an exhaust side with respect to the cylinder group, and is provided in the longitudinal direction along the cylinder group. The second cooling water channel includes an intake-side water jacket. The intake-side water jacket is located on an intake side with respect to the cylinder group, and is provided in the longitudinal direction along the cylinder group. The cylinder block according to the present disclosure is configured such that cooling water at a temperature lower than a temperature of the cooling water flowing through the second cooling water channel flows through the first cooling water channel. That is, the first cooling water channel is configured so that cooling water at a first temperature flows therethrough, the second cooling water channel is configured so that cooling water at a second temperature flows therethrough, and the first temperature is lower than the second temperature.

Air taken into the cylinder from an intake port hits a wall surface of the cylinder on the exhaust side and swirls in the cylinder. According to the above-described configuration of the cylinder block, since the exhaust-side water jacket through which the cooling water at a temperature lower than that in the intake-side water jacket flows is provided on the exhaust side with respect to the cylinder group, heat reception of the air taken into the cylinder from the cylinder wall surface can be suppressed.

If achievement of the above-described effect is the only object, the temperature of the cooling water not only in the exhaust-side water jacket but the entire cylinder block including the intake-side water jacket may be lowered uniformly. However, in such a case, an increase of friction in a sliding portion or an increase of cooling loss is incurred, and enlargement of the size of a radiator is needed. According to the above-described configuration of the cylinder block, by changing the temperature of the cooling water according to the location, such a problem does not occur. That is, according to the above-described configuration of the cylinder block, the cooling effect for the cylinder can be made appropriate.

The exhaust-side water jacket is preferably constituted with as small width (or can be referred to as a thickness) as possible in a direction perpendicular to the axial direction of the cylinder. By reducing the width (thickness) of the exhaust-side water jacket, a flow velocity of the cooling water flowing through the exhaust-side water jacket can be ensured, while an exhaust-side wall surface of the cylinder requiring cooling is reliably cooled, and the flow rate of the cooling water can be suppressed. Preferably, the exhaust-side water jacket is configured so that the width thereof is smaller than a width of the intake-side water jacket.

The exhaust-side water jacket preferably has a depth in the axial direction of the cylinder from a cylinder head abutting surface not made too deep. That is, the exhaust-side water jacket is preferably configured having a small depth. By making the depth of the exhaust-side water jacket small, the flow velocity of the cooling water flowing through the exhaust-side water jacket is ensured, while an exhaust-side wall surface of the cylinder requiring cooling is reliably cooled, and the flow rate of the cooling water can be suppressed. Preferably, the exhaust-side water jacket is configured such that the depth thereof is made smaller than the depth of the intake-side water jacket.

The exhaust-side water jacket is preferably configured to be located in a region from a position of a piston upper surface when an intake valve is lifted to the maximum to a cylinder head abutting surface of the cylinder block in the cylinder axial direction. According to this configuration, a region hit by the air taken into the cylinder from the intake port can be reliably cooled without unnecessarily enlarging the area cooled by the cooling water at a low temperature.

The second cooling water channel is preferably configured to include a second exhaust-side water jacket communicating with the intake-side water jacket. The second exhaust-side water jacket is located on the exhaust side with respect to the cylinder group, and is provided in the longitudinal direction along the cylinder group. This second exhaust-side water jacket is configured to be located in a lower direction of the exhaust-side water jacket in the axial direction of the cylinder. An upper direction in the axial direction of the cylinder refers to a direction where the cylinder head is located, while a lower direction refers to a direction where the crank shaft is located. According to this configuration, a region on an upper side of the exhaust-side wall surface of the cylinder, that is, a region hit by the air taken into the cylinder from the intake port can be cooled efficiently by the cooling water at a low temperature, while a region on a lower side of the exhaust-side wall surface of the cylinder can be cooled appropriately by the cooling water at the same relatively higher temperature as the cooling water flowing through the intake-side water jacket.

In comparison between the exhaust-side water jacket and the second exhaust-side water jacket, the exhaust-side water jacket is preferably configured to have a width in the direction perpendicular to the axial direction of the cylinder smaller than the width of the second exhaust-side water jacket.

The first cooling water channel is preferably configured to include an inter-cylinder channel provided in the width direction of the cylinder block between two adjacent cylinders and connected to the exhaust-side water jacket. According to this configuration, a region sandwiched by the two adjacent cylinders can be cooled by the same relatively low-temperature cooling water as the cooling water flowing through the exhaust-side water jacket.

The inter-cylinder channel is preferably configured to have its channel cross sectional area smaller than a channel sectional area of the exhaust-side water jacket. According to this configuration, the flow rate of the cooling water can be suppressed while the flow velocity of the cooling water flowing through the inter-cylinder channel is ensured.

Moreover, the inter-cylinder channel preferably has at least a part thereof opened in the cylinder head abutting surface of the cylinder block. The opening portion of the inter-cylinder channel can be used as a cooling water inlet for introducing the cooling water into the cylinder block or a cooling water outlet for discharging the cooling water from the cylinder block.

The first cooling water channel is preferably configured to include an end-portion channel. The end-portion channel is provided in the width direction of the cylinder block between at least one of end surfaces of the cylinder block in the longitudinal direction and the cylinder which is the closest to the end surface. The end-portion channel is connected to the exhaust-side water jacket. According to this configuration, the region sandwiched between the end surface of the cylinder block and the cylinder can be cooled by the same relatively low-temperature cooling water as the cooling water flowing through the exhaust-side water jacket.

The end-portion channel is preferably configured to have its channel sectional area smaller than the channel sectional area of the exhaust-side water jacket. According to this configuration, the flow rate of the cooling water can be suppressed while the flow velocity of the cooling water flowing through the end-portion channel is ensured.

Moreover, the end-portion channel preferably has at least a part thereof opened in the cylinder head abutting surface of the cylinder block. The opening portion of the end-portion channel can be used as the cooling water inlet for introducing the cooling water into the cylinder block or the cooling water outlet for discharging the cooling water from the cylinder block.

The exhaust-side water jacket preferably has at least a part thereof opened in the cylinder head abutting surface of the cylinder block. The opening portion of the exhaust-side water jacket can be used as the cooling water inlet for introducing the cooling water into the cylinder block or the cooling water outlet for discharging the cooling water from the cylinder block.

According to the above-described disclosure, the exhaust-side water jacket provided on the exhaust side with respect to the cylinder group and the intake-side water jacket provided on the intake side with respect to the cylinder group are configured as a part of the cooling water channels of the respective systems. By allowing the cooling water at a temperature relatively lower than that of the cooling water flowing through the intake-side water jacket to flow through the exhaust-side water jacket, heat reception of the air taken into the cylinder from the cylinder wall surface can be suppressed without causing an increase of friction of the sliding portion or an increase of cooling loss.

### BRIEF DESCRIPTION OF THE DRAWINGS

FIG. 1 is a view illustrating a configuration of a cooling system of an engine of an embodiment of the present disclosure;

FIG. 2 is a plan view of a cylinder block of the embodiment of the present disclosure;

FIG. 3 is a sectional view illustrating a section perpendicular to a longitudinal direction passing through an intake port of the cylinder block of the embodiment of the present disclosure and is a sectional view illustrating an A-A section in FIG. 2;

FIG. 4 is a sectional view illustrating a section including a center axis of a cylinder of the cylinder block of the embodiment of the present disclosure and perpendicular to the longitudinal direction and is a sectional view illustrating a B-B section in FIG. 2;

FIG. 5 is a sectional view illustrating a section perpendicular to the longitudinal direction passing between two adjacent cylinders of the cylinder block of the embodiment of the present disclosure and is a sectional view illustrating a C-C section in FIG. 2;

FIG. 6 is a sectional view illustrating a section in parallel with a cylinder head abutting surface of the cylinder block of the embodiment of the present disclosure and is a sectional view illustrating a D-D section in FIG. 3;

FIG. 7 is a view illustrating an application example to a supercharging engine system of the cooling system in the engine of the embodiment of the present disclosure;

FIG. 8 is a view illustrating an application example to a hybrid system of the cooling system in the engine of the embodiment of the present disclosure;

FIG. 9 is a sectional view illustrating a section of a cylinder block of a modification 1 of the embodiment of the present disclosure and is a sectional view illustrating a section corresponding to the C-C section in FIG. 2; and

FIG. 10 is a sectional view illustrating a section of a cylinder block of a modification 2 of the embodiment of the present disclosure and is a sectional view illustrating a section corresponding to the D-D section in FIG. 3.

### DETAILED DESCRIPTION OF THE PREFERRED EMBODIMENTS

An embodiment of the present disclosure will be described by referring to the attached drawings. However, the embodiment illustrated below is to exemplify a device or a method for embodying a technical idea of the present disclosure and unless explicitly stated otherwise, structures, arrangement, order of processing and the like of components are not intended to be limiting. The present disclosure is not limited to the embodiment illustrated below but can be embodied with various modifications within a range not departing from the gist of the present disclosure.

### Configurations of Engine Cooling System of the Embodiment

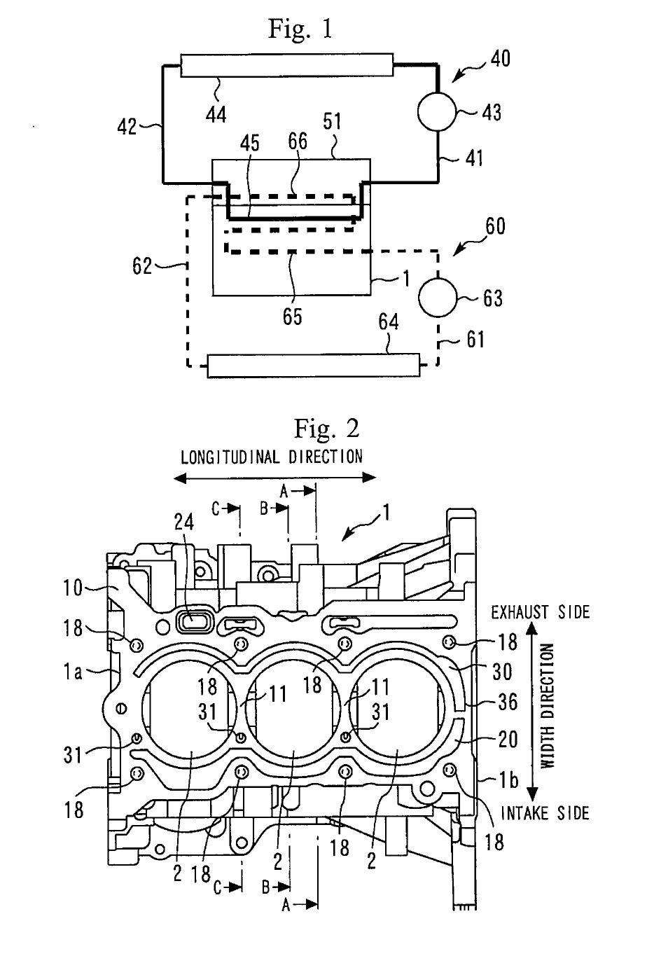

By referring to FIG. 1, a configuration of a cooling system of an engine of this embodiment will be described. Cooling water for cooling the engine is circulated between the engine and a radiator by a circulation system. The engine includes a cylinder block 1 and a cylinder head 51 mounted on the cylinder block 1 through a gasket, not shown. Supply of the cooling water is made to both the cylinder block 1 and the cylinder head 51.

The cooling system of the engine of this embodiment includes two systems of circulation systems 40 and 60. The first circulation system 40 and the second circulation system 60 are both independent closed loops and include radiators 44 and 64 and water pumps 43 and 63, respectively. Moreover, a water temperature sensor and a thermostat for water-temperature adjustment, not shown, might be provided.

The first circulation system 40 includes a first cooling water channel 45 formed inside the cylinder block 1. The first cooling water channel 45 includes an exhaust-side water jacket which will be described later. The first cooling water channel 45 extends into the cylinder head 51 through an opening formed in an abutting surface between the cylinder head 51 and the cylinder block 1 and communicates with a cooling water inlet and a cooling water outlet formed in the cylinder head 51. The cooling water inlet of the cylinder head 51 is connected to a cooling water outlet of the radiator 44 through a cooling-water introduction pipe 41, and the cooling water outlet of the cylinder head 51 is connected to a cooling water inlet of the radiator 44 through a cooling-water discharge pipe 42. The water pump 43 is provided on the cooling-water introduction pipe 41.

The second circulation system 60 includes a second cooling water channel 65 formed inside the cylinder block 1 and a third cooling water channel 66 formed inside the cylinder head 51. The second cooling water channel 65 includes an intake-side water jacket and a second exhaust-side water jacket which will be described later. The second cooling water channel 65 and the third cooling water channel 66 are connected through an opening formed in an abutting surface between the cylinder head 51 and the cylinder block 1. Moreover, a cooling water inlet communicating with the second cooling water channel 65 is formed in the cylinder block 1, and a cooling water outlet communicating with the third cooling water channel 66 is formed in the cylinder head 51. The cooling water inlet of the cylinder block 1 is connected to the cooling water outlet of the radiator 64 through the cooling-water introduction pipe 61, and the cooling water outlet of the cylinder head 51 is connected to the cooling water inlet of the radiator 64 by a cooling-water discharge pipe 62. The water pump 63 is provided on the cooling water introduction pipe 61.

According to the configuration illustrated in FIG. 1, the two circulation systems 40 and 60 can make water-temperature adjustment independently. In more detail, from a cold start, a water temperature of the cooling water flowing through the first cooling water channel 45 is the same as a water temperature of the cooling water flowing through the second cooling water channel 65, but as warming-up of the engine progresses, the water temperature of the cooling water flowing through the first cooling water channel 45 is set to be lower than the water temperature of the cooling water flowing through the second cooling water channel 65.

Subsequently, a configuration of the cylinder block 1 of this embodiment will be described. The description will be made by using a plan view and a sectional view of the cylinder block 1.

### Configuration of Cylinder Block of this Embodiment

### <<Configuration of Cylinder Block Seen on Plan View>>

FIG. 2 is a plan view of the cylinder block 1 of this embodiment. In more detail, this is a plan view of the cylinder block 1 when seen from a side of a cylinder head abutting surface 10 on which the cylinder head is to be mounted. In this Description, as described above, the direction in which the cylinders 2 are juxtaposed is defined as the “longitudinal direction” of the cylinder block 1. A direction orthogonal to the longitudinal direction and perpendicular to the axial direction of the cylinder 2 is defined as the “width direction” of the cylinder block 1. Moreover, in end surfaces la and 1b in the longitudinal direction, the end surface 1b on a side of an output end of the crank shaft is referred to as a “rear end surface”, while an end surface 1a on a side opposite to that is referred to as a “front end surface”. When the cylinder head is mounted on the cylinder block 1 and it is seen from a side of the front end surface 1a, an intake port is located on the right side, while an exhaust port is located on the left side, and in this Description, the right side of the cylinder block 1 when seen from the side of the front end surface 1a is referred to be the “intake side”, while the left side is referred to as the “exhaust side”.

The cylinder block 1 of this embodiment is a cylinder block of a spark ignition type serial 3-cylinder engine. However, the present disclosure can be applied not only to the spark ignition type engine but also to a cylinder block of a compression self-ignited type engine, can be applied to a cylinder block having cylinders in the number other than three, that is, four-cylinders and six-cylinders and can be applied to a cylinder block having cylinder arrangement other than serial such as V-type or horizontally opposed.

In the cylinder block 1, three cylinders 2 are juxtaposed at equal intervals. Between two adjacent cylinders 2, a bulkhead 11 separating the two cylinders 2 is provided. In the cylinder head abutting surface 10, a head bolt insertion hole 18 through which a head bolt for assembling the cylinder head to the cylinder block 1 is inserted is formed. The head bolt insertion holes 18 are arranged four each on the exhaust side and the intake side with respect to the row of the cylinders 2 at substantially equal intervals so as to surround the cylinders 2.

In the cylinder head abutting surface 10, water jackets 30 and 20 are opened. In a region on the exhaust side with respect to the row of the cylinders 2 and closer to the center of the cylinder block 1 than the head bolt insertion hole 18, the exhaust-side water jacket 30 is formed extending in the longitudinal direction along wall surfaces on the exhaust side of the cylinders 2 juxtaposed in a row. A front end of the exhaust-side water jacket 30 in the longitudinal direction reaches the vicinity of the front end surface 1a of the cylinder block 1, while a rear end in the longitudinal direction enters between a rear end surface 1b of the cylinder block 1 and the cylinder 2 closest to the rear end surface 1b. The exhaust-side water jacket 30 constitutes a part of the first cooling water channel formed in the cylinder block 1.

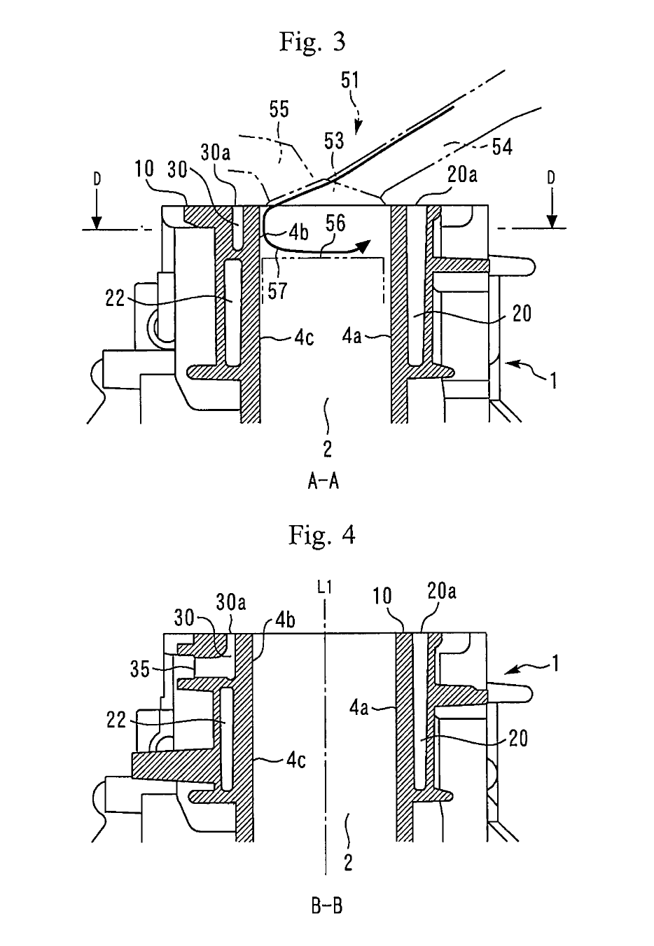

An opening portion 30a (FIG. 3) of the exhaust-side water jacket 30, opened in the cylinder head abutting surface 10, is closed by a gasket when the cylinder head is assembled to the cylinder block 1. However, in a rear end portion 36 of the exhaust-side water jacket 30 in the longitudinal direction, a communication hole communicating with an outlet channel formed in the cylinder head is provided. The exhaust-side water jacket 30 is formed by using a sand core or a die when the cylinder block 1 is cast.

In a region on the intake side with respect to the row of the cylinders 2 and closer to the center of the cylinder block 1 than the head bolt insertion hole 18, the intake-side water jacket 20 is formed extending in the longitudinal direction along the wall surfaces on the intake side of the cylinders 2 juxtaposed in a row. A front end of the intake-side water jacket 20 in the longitudinal direction reaches the vicinity of the front end surface 1a of the cylinder block 1, while a rear end in the longitudinal direction enters between the rear end surface 1b of the cylinder block 1 and the cylinder 2 the closest to the rear end surface 1b. The intake-side water jacket 20 constitutes a part of the second cooling water channel formed in the cylinder block 1.

An opening portion 20a (FIG. 3) of the intake-side water jacket 20, opened in the cylinder head abutting surface 10, is closed by the gasket when the cylinder head is assembled to the cylinder block 1. The intake-side water jacket 20 is formed by using a sand core or a die different from that of the exhaust-side water jacket 30 when the cylinder block 1 is cast.

In the cylinder head abutting surface 10, three holes 31 communicating with the exhaust-side water jacket 30 inside the cylinder block 1 are opened by drilling. The holes 31 are opened in an end portion of the bulkhead 11 on the intake side, that is, a region surrounded by two adjacent cylinders 2 and the intake-side water jacket 20 and also in a region between the front end surface 1a of the cylinder block 1 and the cylinder 2 which is the closest thereto and in the vicinity of the front end of the intake-side water jacket 20. Opening portions of the holes 31 opened in the cylinder head abutting surface 10 become inlets of the cooling water to be introduced into the first cooling water channel. When the cylinder head is assembled to the cylinder block 1 by sandwiching the gasket, these holes 31 communicate with the inlet channel formed in the cylinder head.

Moreover, in the cylinder head abutting surface 10, a communication path 24 communicating with the intake-side water jacket 20 inside the cylinder block 1 is opened. The communication path 24 is provided in a region between the exhaust-side water jacket 30 and the exhaust-side surface of the cylinder block 1. The communication path 24 constitutes the second cooling water channel together with the intake-side water jacket 20. An opening portion of the communication path 24 opened in the cylinder head abutting surface 10 becomes an outlet of the cooling water flowing through the second cooling water channel. When the cylinder head is assembled to the cylinder block 1 by sandwiching the gasket, the communication path 24 communicates with the third cooling water channel formed in the cylinder head. The communication path 24 is formed by the same sand core or die as that for fabricating the intake-side water jacket 20.

Subsequently, a configuration of the inside of the cylinder block 1 of this embodiment will be described by referring to a sectional view. The sections of interest in the cylinder block 1 are a section (A-A section in FIG. 2) perpendicular to the longitudinal direction passing through the intake port, a section (B-B section in FIG. 2) perpendicular to the longitudinal direction including the center axis of the cylinder, a section (C-C section in FIG. 2) perpendicular to the longitudinal direction passing between two adjacent cylinders, and a section in parallel with the cylinder head abutting surface.

<<Internal Configuration of Cylinder Block Seen on Section Perpendicular to Longitudinal Direction Passing through Intake Port>>

FIG. 3 is a sectional view illustrating an A-A section in FIG. 2, that is, a section among the sections perpendicular to the longitudinal direction when seen from the side of the front end of the cylinder block 1 and including an intake port 54 when the cylinder head 51 is assembled to the cylinder block 1. FIG. 3 illustrates the cylinder head 51 and a piston 56 by a two-dot chain line. The cylinder head 51 includes a combustion chamber 53 having a pent roof shape, and to the combustion chamber 53, the intake port 54 and an exhaust port 55 are connected. The intake port 54 is a straight port extending substantially linearly toward the combustion chamber 53 and is constituted as a tumble-flow generating port capable of generating a tumble flow. FIG. 3 illustrates an image of the tumble flow 57 by an arrow line.

In this Description, assuming the cylinder head 51 is located on an upper side in a vertical direction with respect to the cylinder block 1, a positional relationship between each of the elements will be described. This assumption is only for the purpose of facilitation of the description, and this assumption gives no restriction to the configuration of the cylinder block according to the present disclosure.

In the section illustrated in FIG. 3, the intake-side water jacket 20 is formed on the intake side with respect to the row of the cylinders 2. The intake-side water jacket 20 is provided so as to cover a wall surface 4a on the intake side of the cylinder head 2. An upper end of the intake-side water jacket 20 is the opening portion 20a opened in the cylinder head abutting surface 10. This opening portion 20a is closed by the gasket when the cylinder head 51 is assembled to the cylinder block 1.

On the exhaust side with respect to the row of the cylinders 2, the exhaust-side water jacket 30 is formed. The exhaust-side water jacket 30 is provided so as to cover a wall surface 4b on an upper part on the exhaust side of the cylinder head 2. An upper end of the exhaust-side water jacket 30 is the opening portion 30a opened in the cylinder head abutting surface 10. This opening portion 30a is closed by the gasket except a part thereof (an end portion 36 illustrated in FIG. 2) when the cylinder head 51 is assembled to the cylinder block 1.

The exhaust-side water jacket 30 has a depth in the axial direction of the cylinder 2 from the cylinder heed abutting surface 10 smaller than the depth of the intake-side water jacket 20. Specifically, the exhaust-side water jacket 30 is located in a region from the position of the upper surface of the piston 56 at the maximum lift of the intake valve to the cylinder head abutting surface 10 of the cylinder block 1 in the axial direction of the cylinder 2. When the intake valve is opened to the maximum lift, a flow rate of the air taken into the cylinder 2 from the intake port 54 becomes the maximum. The air enters the cylinder 2 while flowing as if crawling on the upper surface of the intake port 54, hits the wall surface 4b of the cylinder 2 on the exhaust side and turns vertically and forms the tumble flow 57. The exhaust-side water jacket 30 is provided in order to cool the wall surface 4b hit by this tumble flow.

The exhaust-side water jacket 30 and the intake-side water jacket 20 are constituted as parts of the cooling water channels of the respective system, and the cooling water at a temperature relatively lower than that of the cooling water flowing through the intake-side water jacket 20 flows through the exhaust-side water jacket 30. Thus, according to the above-described configuration, heat received by the air taken in from the intake port 54 from the wall surface 4b of the cylinder 2 can be suppressed efficiently. Moreover, since the portion through which the low-temperature cooling water flows is limited to the first cooling water channel including the exhaust-side water jacket 30, an increase of friction of the sliding portion of the engine or an increase of cooling loss is not caused by excessive cooling.

On the exhaust side with respect to the row of the cylinders 2, a second exhaust-side water jacket 22 is further formed. The second exhaust-side water jacket 22 is provided below the exhaust-side water jacket 30 so as to cover a wall surface 4c on a lower part on the exhaust side of the cylinder head 2. Though not illustrated in the figure, a shape of the second exhaust-side water jacket 22 seen in the axial direction of the cylinder 2 from the side of the cylinder head abutting surface 10 is substantially the same as the shape of the exhaust-side water jacket 30. That is, the second exhaust-side water jacket 22 extends in the longitudinal direction along the wall surfaces on the exhaust side of the cylinders 2 juxtaposed in a row. The front end of the second exhaust-side water jacket 22 in the longitudinal direction reaches the vicinity of the front end surface of the cylinder block 1. The rear end of the second exhaust-side water jacket 22 in the longitudinal direction is routed between the rear end surface of the cylinder block 1 and the cylinder 2 which is the closest to the rear end surface. The second exhaust-side water jacket 22 is connected to the intake-side water jacket 20. A position of the lower end (bottom portion) of the second exhaust-side water jacket 22 with respect to the cylinder head abutting surface 10 is substantially equal to a position of the lower end of the intake-side water jacket 20 with respect to the cylinder head abutting surface 10.

The second exhaust-side water jacket 22 is connected inside the cylinder block 1 to the communication path 24 illustrated in the plan view in FIG. 2. The second exhaust-side water jacket 22 constitutes the second cooling water channel formed in the cylinder block 1 together with the intake-side water jacket 20 and the communication path 24 illustrated in the plan view in FIG. 2. The second exhaust-side water jacket 22 is formed by the same sand core as that for the intake-side water jacket 20.

When the present disclosure is put into practice, the second exhaust-side water jacket 22 does not necessarily have to be provided. The exhaust-side water jacket 30 can be formed deeper in the axial direction of the cylinder 2. However, by disposing the exhaust-side water jacket 30 through which the cooling water at a relatively low temperature flows on the wall surface 4c hit by the tumble flow 57 in the exhaust-side wall surfaces 4b and 4c and by disposing the second exhaust-side water jacket 22 through which the cooling water at a relatively high temperature flows on the wall surface 4c not hit by the tumble flow 57, the cooling effect for the cylinder 2 can be made more appropriate.

### <<Internal Configuration of Cylinder Block Seen on Section Perpendicular to Longitudinal Direction Including Center Axis of Cylinder>>

FIG. 4 is a sectional view illustrating a B-B section in FIG. 2, that is, a section among the sections perpendicular to the longitudinal direction when seen from the side of the front end of the cylinder block 1 and including a center axis L1 of the cylinder 2. In FIG. 4, a width (thickness) in the direction perpendicular to the axial direction of the cylinder 2 of each of the intake-side water jacket 20, the exhaust-side water jacket 30, and the second exhaust-side water jacket 22 is expressed together with a bore of the cylinder 2.

As illustrated in FIG. 4, the width of the exhaust-side water jacket 30 is smaller than the width of the intake-side water jacket 20 and is smaller than the width of the second exhaust-side water jacket 22. By making the width small, the channel sectional area is reduced, and the flow rate of the cooling water can be suppressed while the flow velocity of the cooling water is ensured. Since the width of the exhaust-side water jacket 30 is made small so as to obtain the sufficient flow velocity, the wall surface 4b of the cylinder 2 on the exhaust side particularly requiring cooling can be reliably cooled, and the heat received by the air taken into the cylinder 2 from the wall surface 4b can be suppressed. Since the width of the exhaust-side water jacket 30 is made small so as to suppress the flow rate of the cooling water, cooling capacity required for the radiator of the first circulation system can be suppressed.

In the section illustrated in FIG. 4, a drain hole 35 communicating with the vicinity of the lower end portion of the exhaust-side water jacket 30 is opened in the side surface of the cylinder block 1 on the exhaust side. This drain hole 35 is for maintenance and is usually closed by a plug. By opening the drain hole 35, the cooling water collecting in the first cooling water channel including the exhaust-side water jacket 30 can be discharged to the outside of the cylinder block 1. Though not shown in the section illustrated in FIG. 4, the similar drain hole is also provided in the second cooling water channel including the intake-side water jacket 20 and the second exhaust-side water jacket 22.

<<Internal Configuration of Cylinder Block Seen on Section Perpendicular to Longitudinal Direction Passing between Two Adjacent Cylinders>>

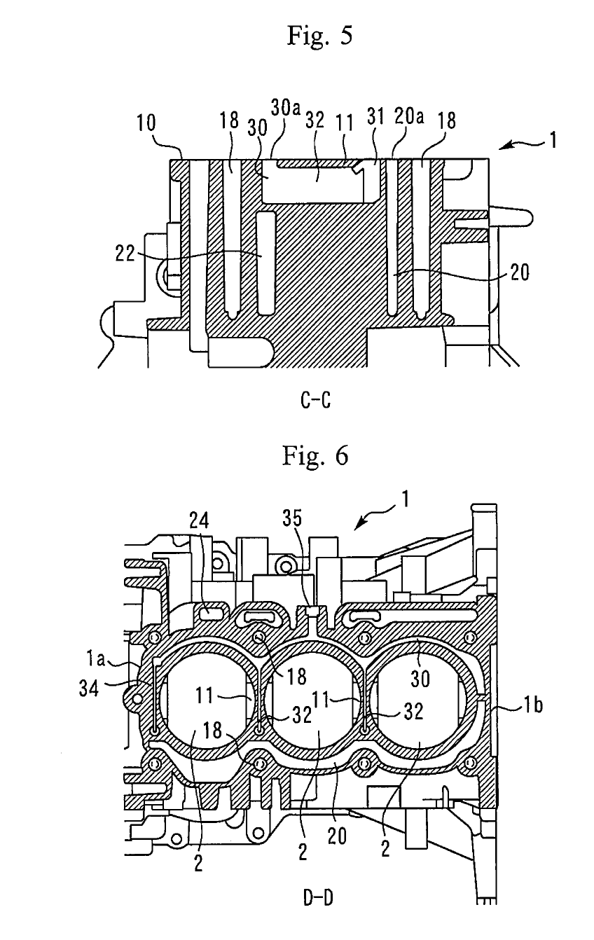

FIG. 5 is a sectional view illustrating a C-C section in FIG. 2, that is, a section passing between the two cylinders in the sections perpendicular to the longitudinal direction when seen from the side of the front end of the cylinder block 1. The head bolt insertion holes 18 are formed on the intake side and the exhaust side, respectively, by sandwiching the bulkhead 11 separating the two cylinders. The section illustrated in FIG. 5 is a section including a center axis of the head bolt insertion hole 18 and perpendicular to the longitudinal direction.

In the bulkhead 11, an inter-cylinder water jacket (inter-cylinder channel) 32 connecting the exhaust-side water jacket 30 and the hole 31 is formed. A depth of the inter-cylinder water jacket 32 is substantially the same as the depth of the exhaust-side water jacket 30. The inter-cylinder water jacket 32 is formed by the same sand core or die as that for the exhaust-side water jacket 30. However, the upper end of the exhaust-side water jacket 30 is the opening portion 30a opened in the cylinder head abutting surface 10, while the upper end of the inter-cylinder water jacket 32 is not opened in the cylinder head abutting surface 10 except the hole 31. This is because a bead of the gasket is to be placed on the upper surface of the bulkhead 11 flat when the cylinder head is assembled to the cylinder block 1. According to the configuration illustrated in FIG. 5, the cooling water flowing in through the hole 31 passes through the inter-cylinder water jacket 32 and enters the exhaust-side water jacket 30.

<<Internal Configuration of Cylinder Block Seen on Section in Parallel with Cylinder Head Abutting Surface>>

FIG. 6 is a sectional view illustrating a D-D section in FIG. 3, that is, a section splitting the exhaust-side water jacket 30 in the sections in parallel with the cylinder head abutting surface 10. In the bulkhead 11 separating the two cylinders, the inter-cylinder water jacket 32 is provided in the width direction of the cylinder block 1. Moreover, between the front end surface 1a of the cylinder block 1 and the cylinder 2 which is the closest thereto, an end-portion water jacket (end-portion channel) 34 is provided in the width direction of the cylinder block 1.

The end-portion water jacket 34 connects the exhaust-side water jacket 30 and the hole 31 illustrated in FIG. 2 inside the cylinder block 1. A depth of the end-portion water jacket 34 is substantially the same as the depth of the inter-cylinder water jacket 32. However, similarly to the inter-cylinder water jacket 32, the upper end thereof is not opened in the cylinder head abutting surface 10 except the hole 31. The end-portion water jacket 34 is formed by the same sand core or die as that for the inter-cylinder water jacket 32 or the exhaust-side water jacket 30. The inter-cylinder water jacket 32 and the end-portion water jacket 34 constitute the first cooling water channel together with the exhaust-side water jacket 30.

When the present disclosure is put into practice, the inter-cylinder water jacket 32 or the end-portion water jacket 34 does not necessarily have to be provided. Moreover, the channel may be such that the cooling water is to be simply passed from the hole 31 to the exhaust-side water jacket 30. However, by cooling the upper part of the cylinder 2 from the side by using these water jackets 32 and 34, the heat reception of the air taken into the cylinder 2 from the wall surface on the side of the cylinder 2 can be effectively suppressed.

The channel sectional area of the inter-cylinder water jacket 32 is smaller than the channel sectional area of the exhaust-side water jacket 30. Moreover, the channel sectional area of the end-portion water jacket 34 is smaller than the channel sectional area of the exhaust-side water jacket 30. It is preferable that an area obtained by totaling the channel sectional areas of the two inter-cylinder water jackets 32 and the channel sectional area of the end-portion water jacket 34 does not exceed the channel sectional area of the exhaust-side water jacket 30. According to this configuration, the flow rate of the cooling water can be suppressed while the flow velocity of the cooling water flowing through the inter-cylinder water jacket 32 and the end-portion water jacket 34 is ensured.

Subsequently, a specific application example of the engine cooling system provided with the cylinder block of this embodiment configured as above will be described.

### Application Example of Engine Cooling System of this Embodiment

### Application example 1

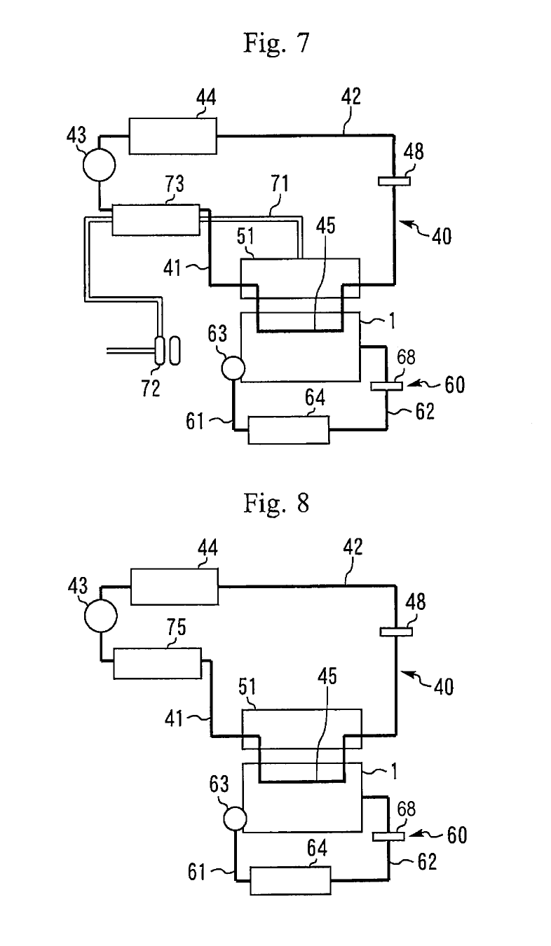

FIG. 7 illustrates an example in which the engine cooling system of this embodiment is applied to a supercharging engine system. A configuration of the engine cooling system itself is common with the basic configuration of the engine cooling system illustrated in FIG. 1. Thus, in FIG. 7, the same reference numerals are given to the elements common with those in the engine cooling system illustrated in FIG. 1. Moreover, duplicated description for the common elements will be omitted or simplified. A water temperature sensor 68, which may be similar to the water temperature sensor 48, is provided with the cooling-water discharge pipe 62.

In the supercharging engine system, a turbo compressor 72 is mounted in the intake passage 71 connected to the cylinder head 51, and a water-cooling intercooler 73 is mounted on a downstream of the turbo compressor 72. In the application example illustrated in FIG. 7, the intercooler 73 is incorporated in the first circulation system 40, and the low-temperature cooling water flowing through the first circulation system 40 is used for heat exchange with air in the intercooler 73. In more detail, the intercooler 73 is arranged in the cooling-water introduction pipe 41, and the cooling water used for heat exchange in the intercooler 73 is introduced into the first cooling water channel 45 provided in the cylinder block 1. In the application example illustrated in FIG. 7, a water-temperature sensor 48 is arranged in the cooling-water discharge pipe 42, and the water temperature of the cooling water having passed through the first cooling water channel 45 is measured by the water-temperature sensor 48. The measured water temperature is used as information for control of the rotation speed of the water pump 43. The low-temperature cooling water flowing through the first circulation system 40 can be used also for cooling of the turbo compressor 72.

### Application example 2

FIG. 8 illustrates an example in which the engine cooling system of this embodiment is applied to a hybrid system. A configuration of the engine cooling system itself is common with the basic configuration of the engine cooling system illustrated in FIG. 1. Thus, in FIG. 8, the same reference numerals are given to the elements common with those in the engine cooling system illustrated in FIG. 1. Moreover, duplicated description for the common elements will be omitted or simplified.

In the hybrid system in which the engine and the motor are combined, an inverter 75 is provided. In the application example illustrated in FIG. 8, the inverter 75 is incorporated in the first circulation system 40, and the low-temperature cooling water flowing through the first circulation system 40 is used for cooling of the inverter 75. In more detail, the inverter 75 is arranged in the cooling-water introduction pipe 41, and the cooling water used for cooling of the inverter 75 is introduced into the first cooling water channel 45 provided in the cylinder block 1. In the application example illustrated in FIG. 8, too, the water-temperature sensor 48 is arranged in the cooling-water discharge pipe 42.

Lastly, two modifications of this embodiment will be described. As in the modifications below, the present disclosure is not limited to the above-described embodiment but is capable of various modifications within a range not departing from the gist of the present disclosure.

### Modification 1 of the Embodiment

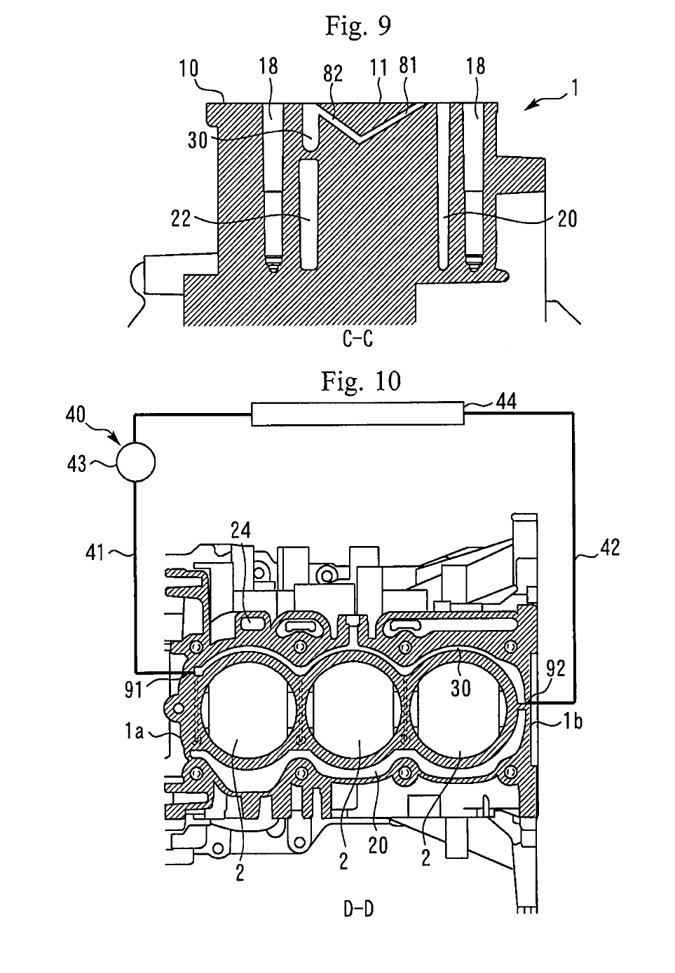

A modification 1 of this embodiment will be described by using FIG. 9. FIG. 9 is a sectional view illustrating a section of a cylinder block of the modification 1 of this embodiment and is a sectional view illustrating a section corresponding to the C-C section in FIG. 2. In the modification 1, drill holes 81 and 82 formed by drilling are provided as an inter-cylinder channel formed in the bulkhead 11 instead of the water jacket formed by a sand core or a die. The one drill hole 81 is drilled diagonally below from the intake side toward the exhaust side, while the other drill hole 82 is drilled diagonally below from the exhaust side toward the intake side, and the both are connected in the bulkhead 11. The drill hole 82 is connected to the exhaust-side water jacket 30, and an opening portion of the drill hole 81 is an inlet of the cooling water. In the modification 1, the drill holes 81 and 82 both constitute the first cooling water channel together with the exhaust-side water jacket 30.

### Modification 2 of the Embodiment

A modification 2 of this embodiment will be described by using FIG. 10. FIG. 10 is a sectional view illustrating a section of a cylinder block of the modification 2 of this embodiment and is a sectional view illustrating a section corresponding to the D-D section in FIG. 3. In the modification 2, the inter-cylinder channel and the end-portion channel are not provided. An inlet channel 91 opened in the front end surface 1a of the cylinder block 1 and an outlet channel 92 opened in the rear end surface 1b of the cylinder block 1 are formed, and they are connected to the exhaust-side water jacket 30. The cooling-water introduction pipe 41 of the first circulation system 40 is connected to an opening portion of the inlet channel 91, and the cooling-water discharge pipe 42 is connected to an opening portion of the outlet channel 92. According to this configuration, the cooling water cooled by the radiator 44 enters the cylinder block 1, passes through the exhaust-side water jacket 30 and is returned to the radiator 44 from the cylinder block 1. The inlet channel 91 can be formed also on the side surface of the cylinder block 1. The same applies to the outlet channel 92.

1. A cylinder block for a multi-cylinder engine, comprising:
a plurality of cylinders juxtaposed in a longitudinal direction of the cylinder block;
a first cooling water channel including an exhaust-side water jacket, the exhaust-side water jacket is on an exhaust side with respect to the plurality of cylinders, along the plurality of cylinders; and
a second cooling water channel including an intake-side water jacket, the intake-side water jacket is on an intake side with respect to the plurality of cylinders, along the plurality of cylinders, wherein
the first cooling water channel includes cooling water at a first temperature, the second cooling water channel includes cooling water at a second temperature, and the first temperature is lower than the second temperature.

2. The cylinder block according to claim 1, wherein
the exhaust-side water jacket has a width in a direction perpendicular to an axial direction of the cylinder smaller than the width of the intake-side water jacket.

3. The cylinder block according to claim 1, wherein
the exhaust-side water jacket has a depth in an axial direction of the cylinder from a cylinder head abutting surface smaller than a depth of the intake-side water jacket.

4. The cylinder block according to claim 1, wherein
the exhaust-side water jacket is in a region in an axial direction of the cylinder from a position of a piston upper surface at a maximum lift of an intake valve to a cylinder head abutting surface of the cylinder block.

5. The cylinder block according to claim 1, wherein
the second cooling water channel includes a second exhaust-side water jacket located on the exhaust side with respect to the plurality of cylinders, the second exhaust-side water jacket is along the plurality of cylinders and communicates with the intake-side water jacket; and
the second exhaust-side water jacket is located below the exhaust-side water jacket in an axial direction of the cylinder.

6. The cylinder block according to claim 5, wherein
the exhaust-side water jacket has a width in a direction perpendicular to the axial direction of the cylinder smaller than a width of the second exhaust-side water jacket.

7. The cylinder block according to claim 1, wherein
the first cooling water channel includes an inter-cylinder channel, and
the inter-cylinder channel is in a width direction of the cylinder block between two adjacent cylinders and is connected to the exhaust-side water jacket.

8. The cylinder block according to claim 7, wherein
the inter-cylinder channel has a channel sectional area smaller than a channel sectional area of the exhaust-side water jacket.

9. The cylinder block according to claim 7, wherein
the inter-cylinder channel has at least a part opened in a cylinder head abutting surface of the cylinder block.

10. The cylinder block according to claim 1, wherein
the first cooling water channel includes an end-portion channel provided in a width direction of the cylinder block between at least one end surface in the longitudinal direction of the cylinder block and a cylinder of the plurality of cylinders which is the closest to the end surface and connected to the exhaust-side water jacket.

11. The cylinder block according to claim 10, wherein
the end-portion channel has a channel sectional area smaller than a channel sectional area of the exhaust-side water jacket.

12. The cylinder block according to claim 10, wherein
the end-portion channel has at least a part opened in a cylinder head abutting surface of the cylinder block.

13. The cylinder block according to claim 1, wherein
the exhaust-side water jacket has at least a part opened in a cylinder head abutting surface of the cylinder block.

14. An internal combustion engine comprising:
a cylinder block including,
a plurality of cylinders juxtaposed in a longitudinal direction of the cylinder block,
a first cooling water channel including an exhaust-side water jacket, the exhaust-side water jacket is on an exhaust side with respect to the plurality of cylinders, along the plurality of cylinders, and
a second cooling water channel including an intake-side water jacket, the intake-side water jacket is on an intake side with respect to the plurality of cylinders, along the plurality of cylinders;
a cylinder head including a combustion chamber, an intake port, and an exhaust port, the cylinder head being assembled to the cylinder block so that the intake port is located on the intake side and the exhaust port is located on the exhaust side;
a first circulation system including a first pipe, a first radiator, and a first water pump, the first pipe communicating with the first cooling water channel; and
a second circulation system including a second pipe, a second radiator, and a second water pump, the second pipe communicating with the second cooling water channel.
